(19) United States
(12) Patent Application Publication
(10) Pub. No.: US 2011/0166312 A1
(43) Pub. Date: Jul. 7, 2011

(54) RHEOLOGY MODIFIER

(75) Inventors: Alexander Klein, Gau-Algesheim (DE); Ulrike Duderstadt, Hasselroth (DE); Joachim Heyne, Limburgerhof (DE); Timo Herold, Hanau (DE)

(73) Assignee: EVONIK GOLDSCHMIDT GMBH, Essen (DE)

(21) Appl. No.: 13/002,426

(22) PCT Filed: May 7, 2009
(86) PCT No.: PCT/EP2009/055511

§ 371 Date: Mar. 18, 2011

(30) Foreign Application Priority Data
Jul. 3, 2008 (DE) 102008040152.8

(51) Int. Cl. C08F 220/18

(52) U.S. Cl. 526/328.5

(57) ABSTRACT

The invention relates to a rheology modifier for improving the flowability of technical plastics, which drastically improves the thermoplastic processing behavior of the plastics without impairing the usage properties of the manufactured molded bodies.

### FIELD OF INVENTION

This invention relates to the use of poly(meth)acrylates as rheology modifiers for processing engineering thermoplastics. Useful engineering plastics to be modified include polyamides, for example PA6 or PA66, polyesters such as for example PBT, PET or PTT, polycarbonates, polylactic acids, polyethers and polysulfones, polyoxymethylenes, poly(meth)acrylates, styrene-acrylonitrile copolymers, acrylonitrile-butadiene-styrene copolymers and polyolefins, for example polypropylene or polyethylene, and also mixtures of one or more of the aforementioned plastics.

### PRIOR ART

US 2004/0108623 A1 (Johnson Polymer) describes molding compositions comprising a host polymer and a low molecular weight addition copolymer having a weight average molecular weight of less than 15000 g/mol, and more preferably less than 5000 g/mol, which consists of at least one (meth)acrylate monomer and optionally at least one vinyl aromatic monomer, wherein the relative energy difference between the host polymer and the addition copolymer is less than 2.2. As host polymer it is possible to use inter alia polycarbonate, ABS, polyester and polyamide, and also blends thereof. Owing to the very low molecular weight of the addition copolymers used, the mechanical properties and/or the notched impact strength are in some instances appreciably reduced compared with the standard molding composition without addition copolymer. The use of these low molecular weight addition copolymers in reinforced molding compositions is evidently associated with an unacceptable reduction in tensile strength and tensile modulus compared with the standard.

DE 10 2005 009 200 (Lanxess) describes molding compositions comprising a partly crystalline thermoplastic polyamide and an addition copolymer of at least one olefin with a methacrylic ester or an acrylic ester, wherein the melt flow index of the addition copolymer is not below 100 g/10 min. The addition copolymer may contain up to 4% by weight of functional groups. The disadvantage with this solution is the use of olefins as comonomers of the addition copolymer resulting in poor weathering stability and poor stability to UV radiation compared with copolymers constructed from (meth)acrylates.

DE 10 2005 050 957 (Lanxess) describes molding compositions comprising a thermoplastic polyester and an addition copolymer of at least one olefin with a methacrylic ester or an acrylic ester, wherein the melt flow index of the addition copolymer is not below 50 g/10 min. The addition copolymer may contain up to 4% by weight of functional groups. The disadvantage with this solution is likewise the use of olefins as comonomers of the addition copolymer resulting in poor weathering stability and poor stability to UV radiation compared with copolymers constructed from (meth)acrylates.

DE 103 28 665 (Bayer MaterialScience) describes compositions comprising an aromatic polycarbonate or polyester carbonate, rubber modified vinyl (co)polymers, vinyl (co)polymers constructed from alpha-methylstyrene and an acrylate fraction, a flame retardant and an antidrip agent. The vinyl (co)polymer has a weight average molecular weight of 1500 to 5000 and a glass transition temperature >40° C. No information is provided as to the weathering stability of the compositions.

DE 199 27 769 (Röhm GmbH) describes an impact modified polymethacrylate molding composition obtained by mixing an impact modified polymethacrylate molding composition with a low molecular weight polymethacrylate molding composition. The low molecular weight polymethacrylate molding composition has a molecular weight of about 50 000.

EP 367 198 (Mitsubishi Rayon Co.) describes a lubricant for a thermoplastic resin, formed from methyl methacrylate which is reacted to form a polymer having a reduced viscosity of not more than 2 dl/g, in the presence of which first polymer a mixture of acrylic esters and styrene is polymerized so as to achieve a reduced viscosity of not more than 1 dl/g for the copolymer formed in the second stage; and thirdly a mixture of methacrylic esters and other monomers copolymerizable therewith is polymerized in the presence of the copolymer formed in the second stage so that a reduced viscosity of not more than 1.5 dl/g results for the final copolymer obtained in the third stage. This manufacturing process is costly and inconvenient.

U.S. Pat. No. 5,260,379 (Eastman Kodak) describes a modifier for polyester resins which is formed from styrene and methyl methacrylate, the glass transition temperatures of the modifier types are between 100° C. and 115° C.

### OBJECT

The object is to provide rheology modifiers for the production of high flowable molding compositions comprising thermoplastically processable engineering plastics which
are simple and hence inexpensive to make,
have good compatibility with customary plastics processing additives or adjuncts, for example glass fibers or carbon fibers or mineral fillers and flame retardants,
have good weathering resistance,
reduce energy requirements in the thermoplastic processing of engineering plastics,
permit gentle incorporation of additives and adjuncts, i.e., reduce fiber breakage in the processing of glass fibers for example,
make it possible to reduce processing temperatures, for example the mold temperature in injection molding and hence provide shorter cycle times,
a very good dispersibility,
ensure high surface quality for injection moldings, particularly at high fill levels and/or low wall thicknesses,
do not impair or even improve the mechanical properties of the high flowable molding compositions compared with customary molding compositions produced without rheology modifier,
provide high heat resistance to the high flowable molding compositions,
have good resistance to other media,
are stable to UV radiation and
display high efficacy, i.e., dramatically raise the flowability of the plastics melt concerned even at low levels of addition.

### ACHIEVEMENT

The objects are achieved by a composition as per claim 1, by a copolymer constructed from the following monomer components:
a. 5% by weight to 95% by weight of at least one methacrylate,
b. 0% by weight to 95% by weight of an acrylate wherein the homopolymer of the acrylate has a glass transition temperature (T₉)<0° C., as measured to DIN EN ISO 11357-1,
c. 0% by weight to 95% by weight of one or more free radically copolymerizable comonomers and
d. 0.1% by weight to 10% by weight of addition polymerization assistants and additives,
   wherein the % by weight sum to 100 and the average molecular weight (Mw) is between 16 000 and 75 000, wherein the average molecular weight is determined via gel permeation chromatography and wherein the copolymer has a T_{g}≦90° C., determined as per DIN EN ISO 11357-1.

### The (Meth)acrylates

(Meth)acrylates are a particularly preferred group of monomers. The term (meth)acrylates comprehends methacrylates and acrylates and also mixtures thereof.

These monomers are widely known. They include inter alia (meth)acrylates derived from saturated alcohols, for example methyl (meth)acrylate, ethyl (meth)acrylate, propyl (meth)acrylate, isopropyl (meth)acrylate, n-butyl (meth)acrylate, tert-butyl (meth)acrylate, pentyl (meth)acrylate, hexyl (meth)acrylate, heptyl (meth)acrylate, octyl (meth)acrylate, isooctyl (meth)acrylate and 2-ethylhexyl (meth)acrylate; (meth)acrylates derived from unsaturated alcohols, for example oleyl (meth)acrylate, 2-propynyl (meth)acrylate, allyl (meth)acrylate, vinyl (meth)acrylate; aryl (meth)acrylates, for example benzyl (meth)acrylate or phenyl (meth)acrylate, wherein the aryl radicals may each be unsubstituted or substituted up to four times; cycloalkyl (meth)acrylates, for example 3-vinylcyclohexyl (meth)acrylate, bornyl (meth)acrylate; hydroxylalkyl (meth)acrylates, for example 3-hydroxypropyl (meth)acrylate, 3,4-dihydroxybutyl (meth)acrylate, 2-hydroxyethyl (meth)acrylate, 2-hydroxypropyl (meth)acrylate; glycol di(meth)acrylates, for example 1,4-butanediol (meth)acrylate, (meth)acrylates of ether alcohols, for example tetrahydrofurfuryl (meth)acrylate, vinyloxyethoxyethyl (meth)acrylate; amides and nitriles of (meth)acrylic acid, for example N-(3-dimethylaminopropyl)(meth)acrylamide, N-(diethylphosphono)(meth)acrylamide, 1-methacryloylamido-2-methyl-2-propanol; sulfur-containing methacrylates, for example ethylsulfinylethyl (meth)acrylate, 4-thiocyanatobutyl (meth)acrylate, ethylsulfonylethyl (meth)acrylate, thiocyanatomethyl (meth)acrylate, methylsulfinylmethyl (meth)acrylate, bis((meth)acryloyloxyethyl) sulfide; polyfunctional (meth)acrylates, for example trimethyloylpropane tri(meth)acrylate.

These monomers can be used alone or in the form of a mixture. Mixtures comprising methacrylates and acrylic esters are particularly preferred.

### The Comonomers

In addition to the (meth)acrylates described above, the compositions to be addition polymerized may also include further unsaturated monomers that are copolymerizable with methyl methacrylate and the aforementioned (meth)acrylates.

These include inter alia 1-alkenes, such as 1-hexene, 1-heptene; branched alkenes, for example vinylcyclohexane, 3,3-dimethyl-1-propene, 3-methyl-1-diisobutylene, 4-methyl-1-pentene; acrylonitrile; vinyl esters, such as vinyl acetate; styrene, substituted styrenes having an alkyl substituent in the side chain, for example α-methylstyrene and α-ethylstyrene, substituted styrenes having an alkyl substituent on the ring, such as vinyltoluene and p-methylstyrene, halogenated styrenes, for example monochlorostyrenes, dichlorostyrenes, tribromostyrenes and tetrabromostyrenes; heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles; vinyl and isoprenyl ethers; maleic acid derivatives, for example maleic anhydride, methylmaleic anhydride, maleimide, methylmaleimide; and dienes, for example divinylbenzene.

In general, these comonomers are used in an amount of 0% by weight to 95% by weight, preferably 0% by weight to 70% by weight, preferably 0% by weight to 40% by weight and more preferably 0% by weight to 20% by weight, based on the weight of the monomers, and the compounds can be used individually or in the form of a mixture.

The addition polymerization is generally started using known free radical initiators. Preferred initiators include inter alia the widely known azo initiators, such as AIBN and 1,1-azobiscyclohexanecarbonitrile, and peroxy compounds, such as methyl ethyl ketone peroxide, acetylacetone peroxide, dilauryl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butylperoxyisopropyl carbonate, 2,5-bis(2-ethylhexanoylperoxy)-2,5-dimethylhexane, tert-butyl peroxy-2-ethylhexanoate, tert-butyl peroxy-3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, mixtures of two or more of the aforementioned compounds with each other and also mixtures of the aforementioned compounds with unmentioned compounds that are likewise capable of forming free radicals.

These compounds are frequently used in an amount of 0.01% by weight to 10% by weight and preferably of 0.5% by weight to 3% by weight, based on the weight of the monomers.

### The Addition Polymerization Assistants and Additives

Useful addition polymerization assistants and additives include for example dispersants, emulsifiers, defoamers, plasticizers, powder flow auxiliaries, or release agents, lubricants and/or thermal stabilizers/antioxidants. When products having a low softening point are worked up via spray drying in particular it is for example chalks or precipitated silicas which are used as powder flow auxiliaries or release agents. Suitable thermal stabilizers and powder flow auxiliaries are disclosed in WO 2004/097083. Chain transfer agents and/or stabilizers can also be included.

### The Chain Transfer Agents

The chain lengths of the addition copolymer can be regulated by addition polymerization of the monomer mixture in the presence of chain transfer agents, as more particularly in the presence of the mercaptans known for this purpose, for example n-butyl mercaptan, n-dodecyl mercaptan, 2-mercaptoethanol or 2-ethylhexyl thioglycolate, pentaerythritol tetrathioglycolate; in which case the chain transfer agents are generally used in amounts of 0.05% by weight to 5% by weight based on the monomer mixture, preferably in amounts of 0.1% by weight to 2% by weight and more preferably in amounts of 0.2% by weight to 1% by weight on the monomer mixture (cf. for example H. Rauch-Puntigam, Th. Völker, “Acryl- and Methacrylverbindungen”, Springer, Heidelberg, 1967; Houben-Weyl, Methoden der organischen Chemie, volume XIV/1, page 66, Georg Thieme, Heidelberg, 1961 or Kirk-Othmer, Encyclopedia of Chemical Technology, Vol. 1, pages 296ff, J. Wiley, New York, 1978). n-Dodecyl mercaptan is preferably used as chain transfer agent. Preferred alternatives are chain transfer agents based on alkyl 3-mercaptopropionate, where alkyl represents methyl, ethyl, n-butyl, 2-ethylhexyl and n-octadecyl.

### The Molding Compositions

Adding at least one rheology modifier of the present invention makes it possible for the thermoplastically processable engineering plastics to be processed into molding compositions that are in accordance with the present invention. The properties of the molding compositions that are in accordance with the present invention can be adjusted, and tailored to the requirements of a wide variety of applications, in a known manner using customary plastics additives without the use of the rheology modifiers resulting in any restriction having to be imposed.

The molding compositions of the present invention are characterized in that they contain
A. 10% by weight to 99.5% by weight, preferably 25% by weight to 99.5% by weight and more preferably 51% by weight to 99.5% by weight of at least one thermoplastically processable engineering plastic,
B. 0.5% by weight to 20% by weight, preferably 1.5% by weight to 15% by weight and more preferably 3% by weight to 10% by weight of at least one rheology modifier of the present invention,
C. 0% by weight to 75% by weight and preferably 5% by weight to 60% by weight of at least one filler, preferably mineral filler based on talc, wollastonite, kaolin and/or glass fibers,
D. 0% by weight to 60% by weight, preferably 4% by weight to 40% by weight and more preferably 10% by weight to 20% by weight of at least one flame retardant,
E. 0% by weight to 40% by weight, preferably 1% by weight to 30% by weight and more preferably 5% by weight to 15% by weight of at least one elastomer modifier,
F. 0% by weight to 10% by weight and preferably 0.1% by weight to 5% by weight of customary plastics additives,
   wherein the sum total of the weight fractions of all components A to F is equal to 100% by weight.

### The Engineering Plastics A

As plastics to be modified there can be used thermoplastically processable engineering plastics, inter alia polyamides (PA) such as for example PA6, PA11, PA12, PA66, PA46, PA610, PA612 or PA6T, polyesters such as for example polybutylene terephthalate (PBT), polyethylene terephthalate (PET), polytrimethylene terephthalate (PTT) or polycarbonates (PC), polylactic acid (PLA), polyethers, for example polyphenylene ethers, polysulfones, for example polyphenylene oxide (PPO) or polyphenylene sulfide (PPS), polyoxymethylene (POM), poly(meth)acrylates, styrene-acrylonitrile copolymers, acrylonitrile-butadiene-styrene copolymers (ABS) and polyolefins, for example polypropylene (PP) or polyethylene, and also copolymers of the aforementioned engineering plastics and mixtures (blends) of the aforementioned engineering plastics with each other or with other plastics.

Preferred engineering plastics are PA6, PA66, PBT, POM, PET, PC, ABS, and also their copolymers and/or plastics mixtures (blends) comprising these engineering plastics. Particularly preferred engineering plastics are PA6, PA66, PBT, PET and PC, their copolymers and/or plastics mixtures (blends) comprising these engineering plastics.

As mixtures (blends) of the engineering plastics there may be used for example PA/ABS, PA/PP, PA/polystyrene, PA/PBT, PA/PET, PBT/ABS, PBT/ASA, PBT/PS, PC/PBT, PC/PET, PC/ABS, PC/SAN, PC/SAN/ABS or PC/ABS/PMMA, which may each comprise one or more compatibilizers.

### The Rheology Modifier B

The rheology modifier of the present invention consists of a copolymer constructed from the following monomer components:
e. 5% by weight to 95% by weight of at least one methacrylate,
f. 0% by weight to 95% by weight of an acrylate wherein the homopolymer of the acrylate has a glass transition temperature (T_{g})<0° C., as measured to DIN EN ISO 11357-1,
g. 0% by weight to 95% by weight of one or more free radically copolymerizable comonomers and
h. 0.1% by weight to 10% by weight of addition polymerization assistants and additives,
   wherein the % by weight sum to 100 and the average molecular weight (Mw) is between 16 000 and 75 000, wherein the average molecular weight is determined via gel permeation chromatography and wherein the copolymer has a T_{g}≦90° C., preferably <80° C. and more preferably <60° C., as determined to DIN EN ISO 11357-1.

The rheology modifier preferably has a molecular weight (Mw) between 16 000 and 40 000. The molecular weight distribution is preferably characterized by 1.5<Mw/Mn<3.5. Particularly setting a Tg in the particularly preferred range <60° C. provides a particularly high efficacy in the thermoplastic processing of the molding compositions of the invention without any impairment in the performance characteristics of the molded articles obtained, as is the case with low molecular weight modifiers. The rheology modifiers preferably comprise at least 3% by weight of acrylate monomer of Tg<0° C. The preferred glass transition temperature of <80° C. is preferably achieved through incorporation of at least 15% by weight of acrylate monomer of Tg<0° C. With regard to the handling of the rheology modifier, a glass transition temperature above 30° C. is advantageous. On the other hand, “soft” rheology modifiers of low Tg (<30° C.) offer advantages in terms of high toughness on the part of the molded articles. For such “soft” rheology modifiers there is the option of preparing a polymer of core-shell construction, for example via emulsion polymerization, in which case the soft rheology modifier forms the core and is surrounded by a shell of Tg>60° C. and this shell preferably in turn has a composition that is in accordance with the present invention.

The comonomer composition according to the present invention and setting the molecular weight according to the invention result in rheology modifiers being obtained that have sufficiently high MVR flowability of at least 5 ccm/10 min and preferably at least 50 ccm/10 min as measured to DIN EN ISO 1133 at 150° C. under a 2.16 kg load. High processing temperatures in particular make thermally stable rheology modifiers preferable, i.e., rheology modifiers that in a dynamically thermogravimetric analysis (TGA) involving heating in nitrogen from room temperature to 300° C. at a heating rate of 10° C. per minute suffer no more than 5% weight loss. Methods of thermal stabilization are disclosed in WO 2004/097083.

The rheology modifier is used in amounts of 0.5% by weight to 20% by weight, based on the overall composition of the molding material of the present invention, preferably in amounts of 1.5% by weight to 15% by weight and more preferably in amounts of 3% by weight to 10% by weight.

### The Filler Component C

As component C) there are used particulate, flake-shaped and more particularly fibrous fillers or reinforcing materials, as described in Gächter, Müller, Kunststoff-Additive, 3rd edition, Hanser-Verlag, Munich, Vienna, 1989, individually or in combination with each other. The fillers may be coated with surface-active substances (sizes). Examples of such fillers are organic fillers, for example natural fibers and wood flour, natural and synthetic chalks and silicas, dolomites, quartzes, silicates, metals, metal oxides, aluminum hydroxide, titanium dioxide, magnesium carbonate, barium sulfate, glass spheres, natural and synthetic silica, silicate hollow spheres, carbon, carbon black, graphite, talc, mica, kaolin, wollastonite, natural and synthetic reinforcing fibers for example natural fibers, carbon fibers, wollastonite fibers, basalt fibers, ceramic fibers, boron fibers, whiskers and glass fibers. Preference is given to mineral fillers based on talc, mica, silicate, quartz, titanium dioxide, wollastonite, silicas, magnesium carbonate, chalk, feldspar, barium sulfate, and/or glass fibers, particularly preferred fillers are talc, wollastonite, kaolin and/or glass fibers. It is known that reinforcing materials in particular, such as glass fibers, as well as desired effects, for example enhanced stiffness, bring about, particularly at comparatively high filler contents, a substantial increase in melt viscosity, i.e. a reduction so that filled standard molding compositions without rheology modifier have low flowability. Such molding compositions have increased energy requirements in processing, leading for example to longer cooling times and possibly to thermal damage on the part of the molded articles. On the other hand, fine thin walled structures or long flow paths are impossible to achieve with highly filled standard molding compositions. Using the rheology modifiers of the present invention provides a dramatic improvement in flowability and the filled molding compositions of the present invention have high flowability compared with the standard.

### The Flame Retardant Component D

The flame retardants used are described in the Plastic Additives Handbook, 5th Edition, Hanser-Verlag, Munich 2001.

It is possible to use commercially available organic halogen compounds with synergists or commercially available organic nitrogen compounds or organic/inorganic phosphorus compounds, and also mineral flame retardants such as for example antimony trioxide, magnesium hydroxide, or calcium magnesium carbonate hydrates, individually or combinations. Useful halogen-containing, more particularly brominated and chlorinated flame retardants include for example ethylene-1,2-bistetrabromophthalimide, epoxidized tetrabromobisphenol A resin, tetrabromobisphenol A oligocarbonate, tertrachlorobisphenol A oligocarbonate, pentabromopolyacrylate, brominated polystyrene. Useful organic phosphorus compounds include for example triphenyl phosphate (TPP), resorcinol bis(diphenyl phosphate) (RDP) and oligomers derived therefrom, and also bisphenol A bisdiphenyl phosphate (BDP) including oligomers, also organic and inorganic phosphinic acid derivatives and their salts moreover red phosphorus, phosphites, hypophosphites, phosphine oxides. Nitrogen compounds used are in particular melamine and melamine cyanurate, melamine phosphate and melamine polyphosphate. Useful synergists include for example antimony compounds, more particularly antimony trioxide and antimony pentoxide, zinc compounds, tin compounds, for example tin stannate and borates. Carbon formers, for example phenol-formaldehyde resins, polycarbonates, polyphenyl ethers, polyimides and tetrafluoroethylene polymers as antidrip agents can likewise be used in conjunction with the aforementioned flame retardants or flame retardant combinations. Preference is given to flame retardant combinations comprising mineral flame retardants.

### The Elastomer Component E

The customary elastomers for impact modification of engineering thermoplastics are used. Useful impact modifiers include, in general, amorphous copolymers having a glass transition temperature below 0° C., inter alia for example acrylate, ASA, diene, organosiloxane, EPDM, SBS, SEBS, ABS, and MBS rubbers, and also impact modifiers based on ethylene, for example EnBA and EMA copolymers. The elastomers can optionally be encapsulated in a thermoplastic shell, for example MMA, by grafting with suitable monomers. The elastomers may optionally be functionalized with reactive groups, for example epoxy or anhydride groups. These and other elastomers used for impact modification are described for example in DE 10 2005 034 999 and the references cited therein.

### The Customary Plastic Additives (Component F)

The customary plastic additives, for example lubricating and demolding assistants, stabilizers, such as UV, thermal, processing stabilizers and antioxidants, nucleating assistants, demolding assistants, antistats, anti-blocking additives, anti-fogging additives, dyes, pigments, color stabilizers, optical brighteners, delusterants, optical diffusers, IR absorbers and IR reflectors, compatibilizers and dispersants can be used alone or in mixture for example as a masterbatch or dry blend and incorporated into the plastics melt or applied to the plastics surface. These and other customary plastic additives are described for example in the Plastic Additives Handbook, 5th Edition, Hanser-Verlag, Munich, 2001.

Stabilizers used include for example sterically hindered phenols, hydroquinones, aromatic secondary amines and diamines, substituted resorcinols, salicylates, benzotriazoles and benzophenones, also various substituted representatives of these groups and mixtures thereof.

Lubricating and demolding agents used are for example ester waxes, pentaerythritol tetrastearate, long chain fatty acids, for example stearic acid, its salts, for example calcium stearate or tin stearate, amine derivatives, montan waxes, and also low molecular weight polyethylene or polypropylene waxes.

Useful nucleating agents include for example sodium and calcium phenylphosphinate, aluminum oxide, silicon oxide and preferably talc.

Useful pigments include for example titanium dioxide, ultramarine blue, iron oxide, carbon black, phthalocyanines, quinacridones, perylenes, nirosine and anthraquinones.

Useful plasticizers include for example phthalates, hydrocarbon oils, N-(n-butyl)-benzenesulfonamide and citric esters.

Additizing the engineering plastic with one or more rheology modifiers and/or the other plastic additives is effected according to the familiar mixing processes, wherein the components are mixed individually or in mixtures as dry blend and/or as masterbatch in the respective weight fractions. The mixing is preferably accomplished by conjoint mingling, blending, kneading, extruding, rolling or pressing of the components. It can be advantageous to produce shaped articles or intermediates from a dryblend of premixed components and/or individual components directly. The molding compositions of the present invention are processed via the familiar thermoplastic processing operations, for example extrusion, injection molding, calendering, deep drawing or thermoforming to form shaped articles or intermediates. Extrusion processes are preferred processing operations and injection molding processes are particularly preferred processing operations.

The flowability of a thermoplastic molding composition imposes limits inter alia on the productivity in the production of molded articles or intermediates from these molding compositions and on the quality and geometry of the molded articles/intermediates. These limits can be overcome with the molding compositions of the present invention.

The advantages of the high flowable molding compositions of the present invention over standard molding compositions without rheology modifier in thermoplastic processing operations, for example extrusion, injection molding, calendering, deep drawing or thermoforming, will now be illustrated by way of example with reference to the processing in injection molding without their use according to the present invention being solely restricted to this thermoplastic processing operation.

The high flowable molding compositions can be injection molded at lower energy requirements, i.e., using lower clamping forces and/or lower melt temperatures compared with standard molding compositions without rheology modifier. Lower clamping forces mean that smaller, less costly injection molding machines can be used. Reduced melt temperatures mean shortened cooling and cycle times, i.e., higher productivity compared with standard. In addition, any thermal damage is diminished at reduced processing temperature and the quality of the component parts is improved. A reduction in the melt temperature on using the high flowable molding compositions may for a given cycle time make it possible to use simple molds having less cooling power. For a given clamping force, cooling power and cycle time, the high flowable molding compositions as compared with standard molding compositions permit if desired finer mold geometries (thinner walled, more complex component parts), or fewer gate marks (i.e., fewer weld lines, fewer weak points) in the case of comparatively large component parts, or an increased number of cavities in the case of multi-impression molds.

In addition, the use of the rheology modifiers of the present invention makes it possible to achieve higher loadings with additives and fillers while retaining adequate flowability. For example, a PA6 molding composition of the present invention that has a 60% by weight glass fiber content can be processed in a similar manner to a standard PA6 molding composition having a glass fiber content of about 30% by weight in injection molding.

### Practice of Invention

### EXAMPLES

### Example RM1

### Inventive

A 5 l addition polymerization vessel equipped with heating/cooling jacket, a stirrer, a reflux condenser and a thermometer was used to heat the aqueous phase consisting of 2840 g of completely ion-free water, 0.72 g of Trilon A, 21 g of sodium carbonate solution (10% by weight), 19.2 g of aluminum sulfate solution (26% by weight), 0.39 g of sodium alkanesulfonate solution (41.4% by weight) and 1.38 g of Lipoxol 6000 solution (10% by weight) to 73° C. While stirring, this aqueous phase was then admixed with a mixture of methyl methacrylate (MMA), n-butyl acrylate (n-BA), n-dodecyl mercaptan (n-DDM), dilauroyl peroxide and stearic acid in the amounts reported in table 1. The batch was addition polymerized at 73° C. for 70 minutes and at 90° C. for 5 minutes and thereafter cooled down to 50° C., admixed with 7.5 g of sulfuric acid (50% by weight) and stirred for 5 min and then further cooled down to room temperature. The addition polymer beads were filtered off, thoroughly washed off with water and dried in a circulating air dryer at 40° C. to a residual moisture content of <0.5% by weight to obtain, at a yield of more than 95% (based on the amount of monomer used), addition polymer beads having an average particle diameter (d50) of about 0.3 mm and also the polymer properties reported in table 2.

To prepare inventive examples RM2 to RM4 and comparative example 1, first in each case an aqueous phase having the same composition as reported in example 1 was prepared and heated to 73° C., similarly to example 1. Next the respective monomer and auxiliary mixture as per table 1 was added with stirring and polymerized similarly to the RM1 example. Inventive example RM4 was prepared using 2-ethylhexyl acrylate (EHA) instead of n-butyl acrylate. Comparative example 1 was prepared completely without addition of n-BA or EHA, i.e., as a purely homopolymeric PMMA. Each bead addition polymer was in turn worked up and dried similarly to example RM1.

A yield of more than 95% was obtained in each case of addition polymer beads having an average particle diameter of 0.2 to 0.5 mm and also the properties reported in table 2.

### Testing of Bead Addition Polymers:

Average particle diameter (d50) of dried beads: determined via laser diffraction spectroscopy using an LS 13 320 from BeckmanCoulter.

Molecular weight: determined as weight average molecular weight (Mw) or as number average molecular weight (Mn) via gel permeation chromatography (GPC/SEC) in tetrahydrofuran eluent on a column combination of porosities 10E6, 10E5, 10E4, 10E3 based on calibration with polystyrene standards, evaluated as PMMA equivalents via universal calibration.

Residual monomer content: the level of residual MMA or n-BA was determined via headspace GC. Unconverted 2-EHA was determined gas chromatographically via liquid injection of an extract solution.

Glass transition temperature (Tg): determined as per DIN EN ISO 11357-1 via differential scanning calorimetry (DSC) from the midpoint temperature of the glass transition stage on 2nd heating from −50° C. to 120° C. at a heating rate of 10° C./min, after the sample of 15 mg was initially conditioned at −50° C. for 5 min, then heated from −50° C. to 120° C. at 10° C./min (1st heating), then cooled down from 120° C. to −50° C. at 80° C. min and maintained at −50° C. for 5 min.

MVR: flowability determined to DIN EN ISO 1133 at 150° C. and 2.16 kg after 16 hours drying at 40° C. in a circulating air dryer.

TABLE 1

| | | Invention | Invention | Invention | Invention | Comparator 1 |
|---|---|---|---|---|---|---|
| | Units | RM 1 | RM 2 | RM 3 | RM 4 | PMMA |
| methyl methacrylate | g | 1382.4 | 1382.4 | 1536 | 1536 | 2400 |
| n-butylacrylate | g | 537.6 | 537.6 | 384 | — | — |
| 2-ethylhexyl acrylate | g | — | — | — | 384 | — |
| n-DDM¹⁾ | g | 49.92 | 24.96 | 49.92 | 49.92 | 28.8 |
| dilauroyl peroxide | g | 49.92 | 49.92 | 49.92 | 49.92 | 28.8 |
| stearic acid²⁾ | g | 0.384 | 0.384 | 0.384 | 0.384 | 0.48 |

¹⁾= n-dodecyl mercaptan
²⁾= technical grade mixture of stearic and palmitic acids

TABLE 2

| | | | Residual | Residual | Residual | | |
|---|---|---|---|---|---|---|---|
| | | | MMA | n-BA | EHA | | MVR |
| | Mw | Mn | content | content | content | Tg | 150° C./2.16 kg |
| Polymer | g/mol | g/mol | wt % | wt % | wt % | ° C. | ccm/10 min |
| RM1 (inv.) | 19.900 | 12.300 | — | — | — | 35 | 214 |
| RM2 (inv.) | 37.450 | 21.300 | 0.3 | 0.24 | — | 45 | 32 |
| RM3 (inv.) | 19.400 | 11.000 | 0.04 | 0.26 | — | 51 | 56 |
| RM4(inv.) | 21.400 | 12.850 | 0.17 | — | 0.08 | 72 | 9.1 |
| PMMA (comp. 1) | 38.350 | 20.850 | 0.22 | — | — | 106 | <0.1 |

### Examples of Molding Compositions Modified According to the Invention

The molding compositions were prepared using the following components:

Polymer 1: commercially available PBT designated Pocan B 1305, a commercial product from Lanxess Deutschland GmbH, Leverkusen, Germany.

Glass fiber 1: commercially available glass fiber designated CS 7967, a commercial product from Lanxess N. V., Antwerp, Belgium

Polymer 2: commercially available PA6 designated Durethan B29, a commercial product from Lanxess Deutschland GmbH, Leverkusen, Germany.

Glass fiber 2: commercially available glass fiber designated CS 7928, a commercial product from Lanxess N. V., Antwerp, Belgium

Additives: commercially available montan wax demolding assistant and commercially available stabilizer mix, Irganox B 1171 from Ciba Lampertheim GmbH, Lampertheim, Germany.

### Testing of Molding Compositions

Melt viscosity: determined on dried molding composition pellets at the reported temperatures and shear rates in line with DIN/ISO 1133 by extrapolation from the respective flow curve determined using Rheograph 2003 high pressure capillary rheometer from Göttfert GmbH, Buchen, Germany, and Rabinowitsch-Gleiβle correction of inflow effects.

PBT molding compositions C1 to C6 were vacuum dried at 120° C. for 4 h.

PA6 molding compositions C7 to C11 were vacuum dried at 80° C. for 8 h.

Viscosity number of PBT molding compositions: determined to DIN 53 728-3 or ISO 1628-5 in a 1:1 1,2-dichlorobenzene/phenol mixture at 25° C. using AVS 360 Ubbelohde viscometer from Schott Instruments GmbH, Mainz, Germany, with correction for the presence of glass fibers and, where applicable, the presence of rheology modifier.

Ash: determined to DIN EN ISO 3451-1 using CEM microwave asher from CEM GmbH. Kamp-Lintfort, Germany, at 625° C. on dried samples.

Impact strength: determined by IZOD method as per DIN EN ISO 180/1U at 23° C.

Notched impact strength: determined according to IZOD method as per DIN EN ISO 180/1A at 23° C.

Tensile test to determine tensile strength, elongation at break and tensile modulus of elasticity: determined to DIN EN 527-1/1A.

Flexural test to determine flexural strength, edge fiber elongation and flexural modulus: determined to DIN EN ISO 178.

Flexural strength and edge fiber elongation after hydrolysis: test specimens are stored at 95° C. and 90% relative humidity in a conditioning chamber for 10 days. This is followed by a flexural test to DIN EN ISO 178.

Heat distortion temperature HDT-A: determined to DIN EN ISO 75 at 120 K/h heating rate.

Density: determined to ISO 1183 method A

### Examples C1 to C6

### Reinforced PBT

Compounding (PBT): pellet PBT was pre-dried in a dry air dryer at 120° C. for 4 h. The rheology modifiers were pre-dried in a circulating air dryer at 30° C. for 24 h. The PBT-based molding compositions of tables 3 and 4 were compounded using ZSK25 twin screw extruder (Coperion Werner & Pfleiderer GmbH & Co. KG, Stuttgart, Germany) at melt temperatures of about 250 to 255° C., a throughput of 10 kg/h and a screw speed of 125 revolutions per minute and the melt was led through a waterbath into a strand pelletizer and subsequently pelletized. The extruder drive torque reported in tables 3 and 4 was measured. The melt viscosity of the PBT molding compositions was then determined at 260° C. and 1000 1/s and also 1500 1/s from the flow curves reproduced in FIG. 1.

Test specimen production (PBT): following 4 h drying of the PBT molding compositions at 120° C. in a circulating air dryer the test specimens for the mechanical tests in tables 3 and 4 were produced using an Arburg 320M850-210 injection molding machine at 270° C. melt temperature and 70° C. mold temperature, as follows:

1) type 1 test specimens (ISO standard bar 80 mm×10 mm×4 mm) injection molded to ISO 294 using a Campus mold.

2) type 1A tensile bars (80 mm×10 mm×4 mm) injection molded to DIN EN ISO 527-1 using a Campus mold.

As is evident from table 3 and table 4, the inventive molding compositions C3 to C6 are notable in compounding, compared with the comparative tests C1 and C2, for a low extruder torque and a distinctly reduced melt viscosity. These positive effects, for example when the inventive rheology modifier RM1 is used for producing the inventive molding composition C3, are solely due to the rheology modifier's flow improving effect, as is evident from the viscosity numbers and ash residues determined for C1 and C3. Despite the dramatic improvement in flowability on using the inventive rheology modifiers, the mechanical properties remain virtually unchanged or, in particularly preferred embodiments, are even improved in some cases, as is evident from the enhanced toughness and the enhanced flexural moduli.

The good heat resistance and hydrolysis resistance of the molding composition of the present invention is remarkable. In addition, all the test specimens formed from the molding compositions of the present invention display high surface quality.

TABLE 3

| | | Test No. | | |
|---|---|---|---|---|
| | | Comparator 2 | Comparator 3 | Invention |
| | | C1 | C2 | C3 |
| Polymer 1 (PBT) | wt % | 70 | 65 | 65 |
| Glass fiber 1 | wt % | 30 | 30 | 30 |
| Rheology modifier | | none | PMMA | RM1 |
| Modifier content | wt % | 0 | 5 | 5 |
| Extruder torque | % | 64 | 59 | 49 |
| Ash | wt % | 30.1 | 29.7 | 29.4 |
| Viscosity number | ccm/g | 103 | — | 110 |
| SV* (260° C., 1000 1/s) | Pas | 197 | 177 | 116 |
| SV* (260° C., 1500 1/s) | Pas | 164 | 147 | 93 |
| Impact strength (IZOD, RT) | kJ/m² | 53 | — | 58 |
| Tensile strength | MPa | 138 | — | 138 |
| Elongation at break | % | 2.8 | — | 2.8 |
| Tensile modulus of elasticity | MPa | 10170 | — | 9965 |
| Flexural strength | MPa | 213 | — | 209 |
| Flexural strength after hydrolysis | MPa | 173 | — | 180 |
| Edge fiber elongation at flexural | % | 3.7 | — | 3.4 |
| strength | | | | |
| Edge fiber elongation (in flexure) | % | 2.6 | — | 2.7 |
| after hydrolysis | | | | |
| Flexural modulus | MPa | 7911 | — | 7952 |
| HDT-A | ° C. | 199 | — | 203 |
| Density | g/ccm | 1.53 | — | 1.51 |

*melt viscosity

TABLE 4

| | | Test No. | | |
|---|---|---|---|---|
| | | Invention | Invention | Invention |
| | | C4 | C5 | C6 |
| Polymer 1 (PBT) | % | 65 | 65 | 65 |
| Glass fiber 1 | % | 30 | 30 | 30 |
| Rheology modifier | | RM2 | RM3 | RM4 |
| Modifier content | % | 5 | 5 | 5 |
| Extruder torque | % | 54 | 54 | 51 |
| Ash | wt % | 29.5 | 30.0 | 29.7 |
| SV* (260° C. 1000 1/s) | Pas | 142 | 141 | 136 |
| SV* (260° C. 1500 1/s) | Pas | 116 | 116 | 112 |
| Impact strength (IZOD, RT) | kJ/m² | 56 | 60 | 53 |
| Tensile strength | MPa | — | — | — |
| Elongation at break | % | — | — | — |
| Tensile modulus of elasticity | MPa | — | — | — |
| Flexural strength | MPa | 214 | 211 | 202 |
| Edge fiber elongation at | % | 3.5 | 3.4 | 3.5 |
| flexural strength | | | | |
| Flexural modulus | MPa | 8049 | 7784 | 7413 |

*melt viscosity

### Examples C7 to C11

### Reinforced PA6

Compounding (PA6): pellet PA6 was pre-dried in a dry air dryer at 100° C. for 4 h. The rheology modifiers were pre-dried in a circulating air dryer at 30° C. for 24 h. The PA6-based molding compositions of table 5 were compounded using ZSK25 twin screw extruder (Coperion Werner &Pfleiderer GmbH & Co. KG, Stuttgart, Germany) at melt temperatures of about 255 to 260° C., a throughput of 10 kg/h and a screw speed of 125 revolutions per minute and the melt was led through a waterbath into a strand pelletizer and subsequently pelletized. The extruder drive torque reported in table 5 was measured. The melt viscosity of the PA molding compositions was then determined at 270° C. and 1000 1/s and also 1500 1/s from the flow curves reproduced in FIG. 2.

Test specimen production (PA6): following 8 h drying of the reinforced PA6 molding compositions at 80° C. in a circulating air dryer, the test specimens for the mechanical tests in table 5 and 6 were produced using an Arburg 320M850-210 injection molding machine at 270° C. melt temperature and 80° C. mold temperature, as follows:
1) type 1 test specimens (ISO standard bar 80 mm×10 mm×4 mm) injection molded to ISO 294 using a Campus mold.
2) type 1A tensile bars (80 mm×10 mm×4 mm) injection molded to DIN EN ISO 527-1 using a Campus mold.

As is evident from table 5, the inventive molding compositions C8 to C11 are again notable in compounding, compared with the comparative test C8, for a reduced torque requirement in compounding and reduced melt viscosity. Despite the dramatic improvement in flowability, the mechanical properties again remain at a high level or, as in the case of the tensile and flexural moduli for example, are even improved. The test specimens formed from the molding compositions of the invention again display high surface quality.

TABLE 5

| | | Test No. | | | | |
|---|---|---|---|---|---|---|
| | | Comparator | Invention | Invention | Invention | Invention |
| | | C7 | C8 | C9 | C10 | C11 |
| Polymer 2 (PA6) | wt % | 69.5 | 64.5 | 64.5 | 64.5 | 65 |
| Glass fiber 2 | wt % | 30 | 30 | 30 | 30 | 30 |
| Additives | wt % | 0.5 | 0.5 | 0.5 | 0.5 | 0.5 |
| Rheology modifier | | none | RM1 | RM2 | RM3 | RM4 |
| Modifier content | % | 0 | 5 | 5 | 5 | 5 |
| Extruder torque | % | 75 | 64 | 59 | 61 | 60 |
| Ash | wt % | 29.7 | 30.3 | 29.4 | 29.4 | 29.1 |
| SV* (270° C. 1000 1/s) | Pas | 164 | 96 | 106 | 94 | 109 |
| SV* (270° C. 1500 1/s) | Pas | 134 | 79 | 84 | 76 | 86 |
| Impact strength | kJ/m² | 80 | 79 | 75 | 76 | 80 |
| (IZOD, RT) | | | | | | |
| Tensile strength | MPa | 167 | 163 | — | 161 | — |
| Elongation at break | % | 3.7 | 3.3 | — | 3.4 | — |
| Tensile modulus of | MPa | 9487 | 9679 | — | 9563 | — |
| elasticity | | | | | | |
| Flexural strength | MPa | 252 | 250 | 250 | 247 | 245 |
| Edge fiber elongation | % | 4.6 | 4.3 | 4.3 | 4.2 | 4.4 |
| at flexural strength | | | | | | |
| Flexural modulus | MPa | 7648 | 8026 | 7879 | 7852 | 7772 |

*melt viscosity

The molding compositions endowed with the rheology modifier of the present invention can be processed into a wide variety of molded plastics articles, for example into injection moldings used in automotive engineering as body parts on the outside or as component parts in the interior of the automobile or in electrical engineering/electronics, for example as plug casings or as switches, also into casing parts or as coverings. The molding compositions endowed with the rheology modifier of the present invention can further be processed into interior components for ships, airplanes, buses and rail vehicles, into household articles and into garden utensils. The molding compositions endowed with the rheology modifier of the present invention can also be processed into profiles.

### FIGURE DESCRIPTION

FIG. 1 and FIG. 2 illustrate the dependence of melt viscosity on shear rate.

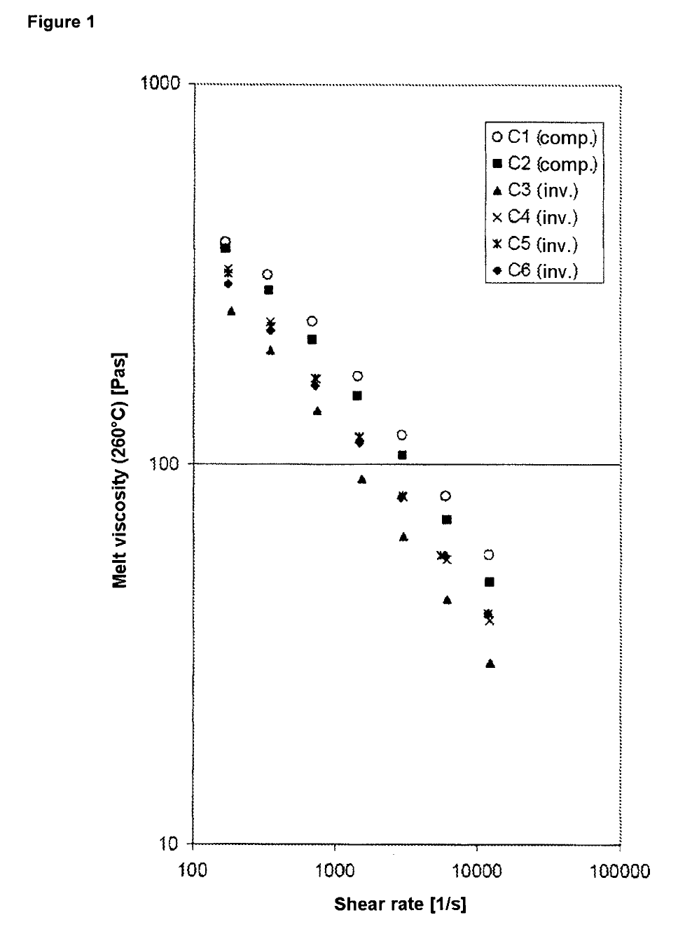

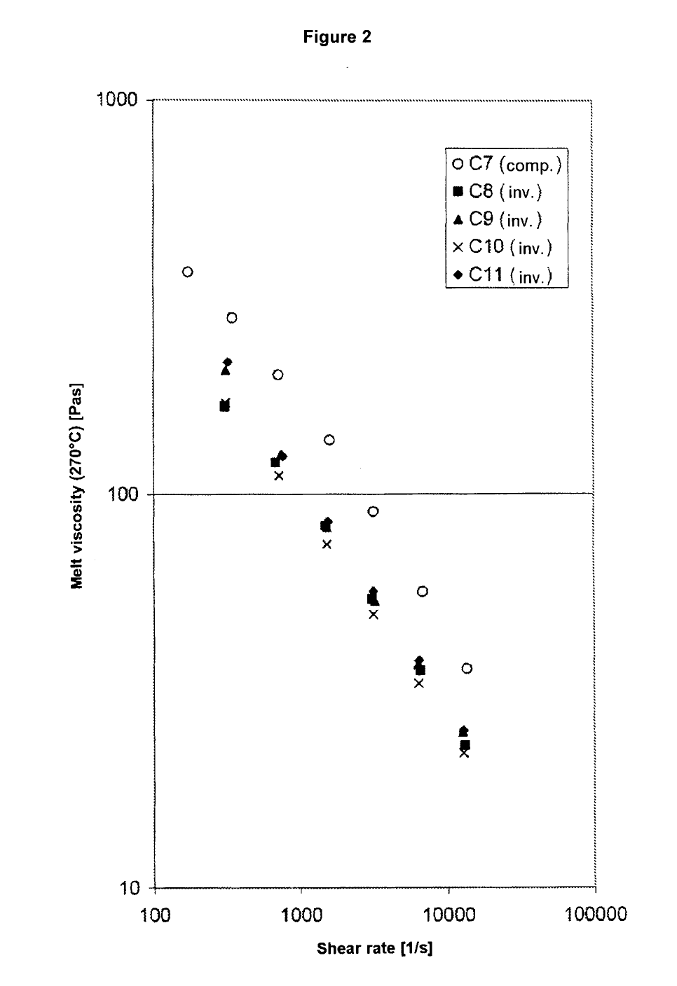

1. A copolymer comprising the following monomer components:
a. 5% by weight to 95% by weight of at least one methacrylate,
b. 0% by weight to 95% by weight of an acrylate wherein the homopolymer of the acrylate has a glass transition temperature <0° C., as measured to DIN EN ISO 11357-1,
c. 0% by weight to 95% by weight of one or more free radically copolymerizable comonomers and
d. 0.1% by weight to 10% by weight of an addition polymerization assistant and/or additive,
wherein the % by weight sum to 100 and the average molecular weight (Mw) is between 16000 and 75000 and the average molecular weight is determined via gel permeation chromatography and the glass transition temperature of the copolymer (Tg), determined as per DIN EN ISO 11357-1, is ≦90° C.

2. The copolymer according to claim 1,
wherein the average molecular weight (Mw) is between 16 000 and 40 000, wherein the average molecular weight is determined via gel permeation chromatography and the glass transition temperature of the copolymer (Tg), determined as per DIN EN ISO 11357-1, is ≦90° C.

3. The copolymer according to claim 1,
wherein the average molecular weight (Mw) is between 16 000 and 75 000, wherein the average molecular weight is determined via gel permeation chromatography and the glass transition temperature of the copolymer (Tg), determined as per DIN EN ISO 11357-1, is <80° C.

4. The copolymer according to claim 1,
wherein the average molecular weight (Mw) is between 16 000 and 40 000, wherein the average molecular weight is determined via gel permeation chromatography and the glass transition temperature of the copolymer (Tg), determined as per DIN EN ISO 11357-1, is <80° C.

5. The copolymer according to claim 1,
wherein the average molecular weight (Mw) is between 16 000 and 75 000, wherein the average molecular weight is determined via gel permeation chromatography and the glass transition temperature of the copolymer (Tg), determined as per DIN EN ISO 11357-1, is <60° C.

6. The copolymer according to claim 1,
wherein the average molecular weight (Mw) is between 16 000 and 40 000, wherein the average molecular weight is determined via gel permeation chromatography and the glass transition temperature of the copolymer (Tg), determined as per DIN EN ISO 11357-1, is <60° C.

7. The copolymer according to claim 1,
comprising
methyl methacrylate.

8. A molding composition,
comprising a copolymer according to claim 1 as a rheology modifier.

9. The molding composition according to claim 8,
wherein
the rheology modifier content is between 0.5% by weight and 20% by weight.

10. The molding composition according to claim 9,
wherein
the rheology modifier content is between 1.5% by weight and 15% by weight.

11. The molding composition according to claim 10,
wherein
the rheology modifier content is between 3% by weight and 10% by weight.

12. The copolymer according to claim 1,
comprising
at least 15% by weight of an acrylate wherein the homopolymer of the acrylate has a glass transition temperature <0° C., as measured to DIN EN ISO 11357-1.

13. The copolymer according to claim 12,
comprising
ethyl acrylate, n-butyl acrylate, propyl acrylate and/or ethylhexyl acrylate.

14. (canceled)

15. A molded plastics article comprising a composition according to claim 8.
